(19) United States
(12) Patent Application Publication
(10) Pub. No.: US 2011/0299239 A1
(43) Pub. Date: Dec. 8, 2011

(54) Computer Case with Upwardly Oriented Add-On Cards and Vertical Airflow

(75) Inventor: Wallace Santos, Union, NJ (US)

(73) Assignee: EZ-TECH CORP (D/B/A MAINGEAR), Kenilworth, NJ (US)

(21) Appl. No.: 12/795,780

(22) Filed: Jun. 8, 2010

(51) Int. Cl. G06F 1/20; G06F 1/16

(52) U.S. Cl. 361/679.49; 361/679.02; 29/464

(57) ABSTRACT

Embodiments of the disclosed technology comprise a method of dissipating heat from within a case of a computer, and a computer case designed therefor, which functions by placing add-on cards into the computer housing or case. In this manner, convection aids in cooling off the interior of the computer as the add-on cards, which generate significant amounts of heat in some computer systems, are placed at the top. As it is unsightly to have add-on cards and their corresponding cables, and the like, exiting from the top of a computer case, in embodiments of the disclosed technology, an air channel is created between the top of the case, comprising portals for add-on cards, and a top panel. A fan may be used to aid in pushing air out of the top channel.

### FIELD OF THE DISCLOSED TECHNOLOGY

The disclosed technology relates generally to hardware cases and more specifically to personal and commercial computer cases.

### BACKGROUND OF THE DISCLOSED TECHNOLOGY

Computer cases are generally metal or hard plastic housings which hold and protect sensitive components housed therein. These components, such as motherboards (or main boards), power supplies, disk drives, add-on cards, and the like are affixed to the interior of the case. However, a known problem in the art of personal computers is that of heat dissipation.

Processors, such as central processing units on a motherboard or a video card, produce a lot of heat. Above a certain temperature, the operation of the computer becomes hindered, and this condition may even result in the destruction of parts thereof. In high performance computers, such as those with cutting edge or over-clocked processors, heat is a major problem. If the temperature can be kept within an acceptable tolerance range, then the processor can run at faster speeds (and generate more heat). However, where this is not possible, the processor must be kept at slower speeds to avoid overheating. Numerous prior art methods of solving this problem exist, including cooling fans, super cooling apparatuses, heat sinks, and the like.

Thus, there has been a long felt need to reduce heat from the vicinity of key components of a computer to allow for greater heat generation, and thus, faster operation.

### SUMMARY OF THE DISCLOSED TECHNOLOGY

It is therefore an object of the disclosed technology to provide a computer case or housing which efficiently dissipates heat.

It is a further object of the disclosed technology to allow for the usage of off-the-shelf computer parts within the computer case.

It is yet another object of the disclosed technology to place items which generate or exhaust heat, near the top of the housing.

Thus, in an embodiment of the disclosed technology, a computer case has an interior cavity formed within a top, bottom, left, right, front, and rear side. Distinguishing the sides from each other, the bottom side is adapted for placement on a generally flat surface. “Generally” and “generally flat” for purposes of this disclosure are defined as a surface which is considered flat by a casual observer/user of a table top and/or a planar surface within a tolerance level of 3 degrees. The bottom side may further include at least one or more feet adapted for placement on such a generally flat surface. The top side is generally parallel (again, meaning parallel according to a casual observer and/or within a tolerance level of 3 degrees from end to end) to the bottom side, and both the top and bottom are elongated, flat surfaces. The top side further has an air channel formed between the top side and top side cover. It is through this air channel that a large amount of heat rises out of the interior cavity of the case and exits the case. The top side further has a series of rectangular portals extending between the internal cavity and the air channel, each rectangular portal adapted for fixed abutment to an add-on card. That is, an add-on card may be secured, such as screwed into, the case, a portion thereof, extending through or abutting the rectangular slot, so that cables may be attached to it.

In embodiments of the computer case, the front side may have at least one switch operable to affect a function of a computer, such as a power switch, reset switch, or the like. The front side is differentiated from the back side, which in embodiments of the disclosed technology, is a planar surface or generally planar surface lacking switches, buttons, or user-interface components. The front side may also have drive bays, one or more of which may be open to the outside. The top panel, however, that is the exterior of the top portion of the case, in embodiments of the disclosed technology, has an electrical port, the electrical port electrically connected to a motherboard housed within said case. Such an electrical port may be a USB (universal serial bus), RJ-45 (network), or other port.

The computer case may also have means, such as screws or other securing or fastening devices known in the art for mounting the motherboard to the case, in an orientation whereby add-on slots on the motherboard are mounted such that an exterior side of the add-on card slot (or seating) causes an add-on card placed therein to have the external side facing towards the top, e.g., abutting an above-described rectangular portal.

A bottom air channel may be formed between a bottom divider and a bottom portion of the computer case. A power supply may be placed within this bottom air channel.

A fan, in embodiments of the disclosed technology, directs air from the internal cavity into the top air channel and out to an exterior of said case. An add-on card may be a video card, the video card abutting one of the rectangular slots, and comprising a video port situated in the top air channel.

A method of orienting devices within a computer case is also disclosed and claimed. A computer case having a top, bottom, left, right, front, and rear side formed around an internal cavity is placed on its bottom, onto a generally flat surface by way of feet attached to the bottom of the computer case. An exterior portion of at least one add-on card is extended through an add-on slot, the exterior portion pointed in an upward direction, relative to the ground. A top side cover is placed over the top side of the computer case and forms an air channel between the exterior portion of the add-on card and the top panel, and at least one fan is electrically connected to a motherboard housed within the computer case.

Elements of the device of the disclosed technology are also applicable to the method of use.

### BRIEF DESCRIPTION OF THE DRAWINGS

FIG. 1 shows a first side elevation view of a case of an embodiment of disclosed technology.

FIG. 2 shows a top perspective view of a case of an embodiment of the disclosed technology.

FIG. 3 shows a top view of a case of an embodiment of the disclosed technology.

FIG. 4 shows a front side elevation view in an embodiment of the disclosed technology.

FIG. 5 shows a bottom plan view of a case of an embodiment of the disclosed technology.

FIG. 6 shows a second side elevation view of another case of an embodiment of the disclosed technology.

FIG. 7 shows a back side elevation view of a case of an embodiment of the disclosed technology.

### DETAILED DESCRIPTION OF EMBODIMENTS OF THE DISCLOSED TECHNOLOGY

Embodiments of the disclosed technology comprise a method of dissipating heat from within a case of a computer, and a computer case designed therefor, which functions by placing add-on cards into the computer housing or case. In this manner, convection and the heat stack effect aids in cooling off the interior of the computer, as the add-on cards, which generate significant amounts of heat in some computer systems, are placed at the top. As it is unsightly to have add-on cards and their corresponding cables, and the like, exiting from the top of a computer case, in embodiments of the disclosed technology, an air channel is created between the top of the case, comprising portals for add-on cards, and a top panel. A fan may be used to aid in pushing air out of the top channel.

Embodiments of the disclosed technology will become clearer below, while viewing the figures.

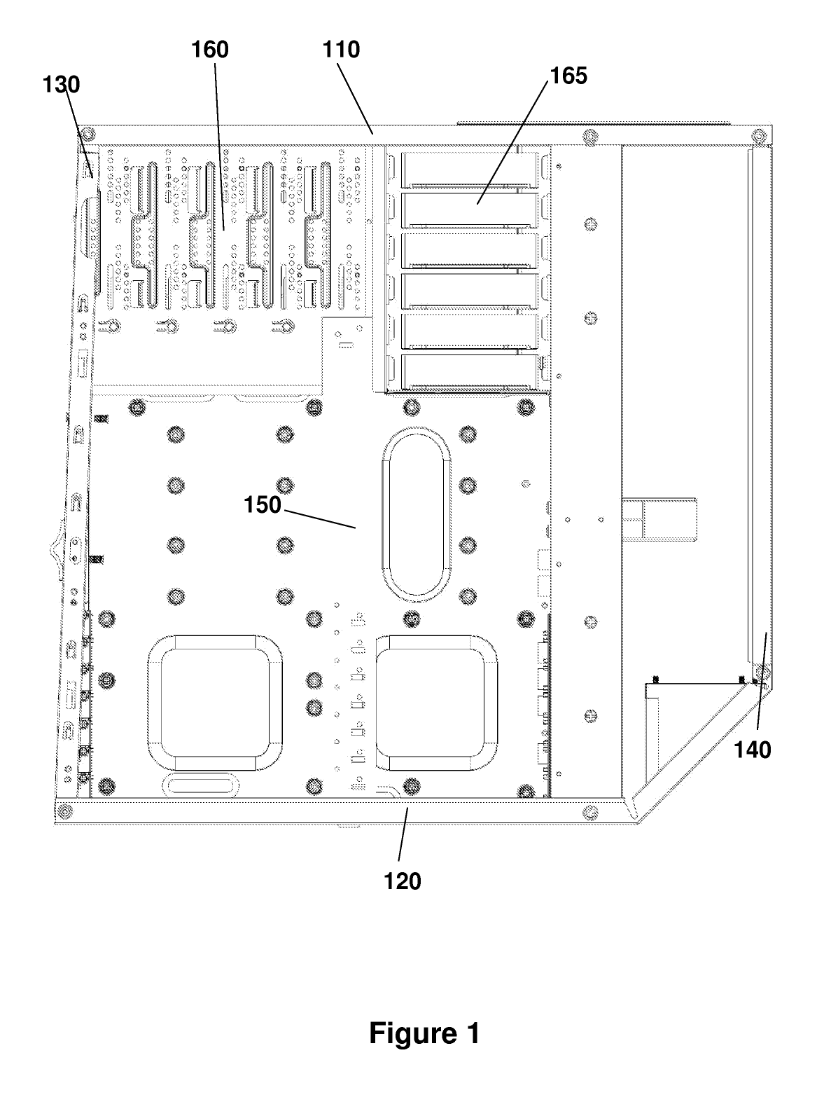

FIG. 1 shows a first side elevation view of a case of an embodiment of the disclosed technology. Shown in the figures is a bare case, with a top side 110, bottom side 120, front side 130, and back side 140. Such a computer case may comprise elements such as drive bays 160, sides 150 (which may comprise metal plates or structural supports), and swappable drive bays 165. In the embodiment shown in FIG. 1, the drive bays 160 are near the front of the computer, which may further have switches, such as a power switch, reset switch, or the like, and the swappable drive bays 165 (for placement therein of a hard drive or other type of disk) are situated there below.

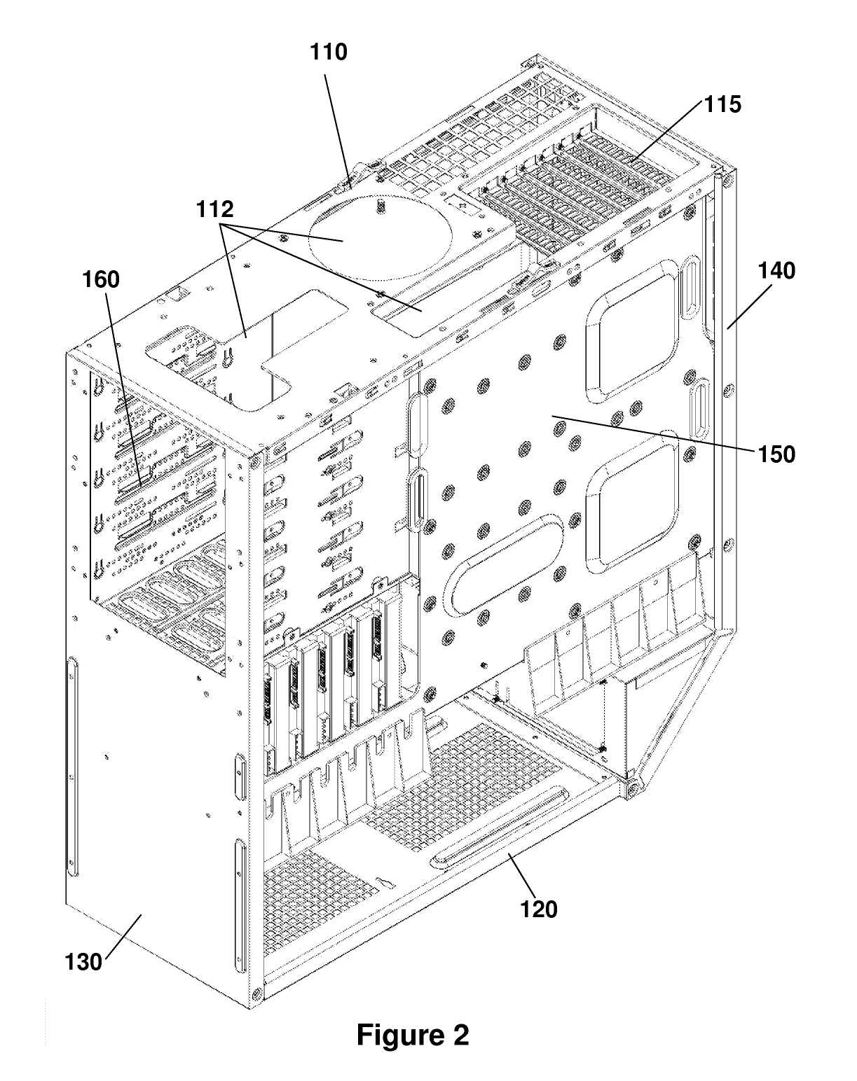

FIG. 2 shows a top perspective view of a case of an embodiment of the disclosed technology. A portal on the front side 130 forms part of open drive bays 160. On the top side are elongated rectangular portals 115 adapted for abutment of add-on cards known in the industry. These add-on cards are typically PCI (Peripheral Component Interconnect) cards, at the time of this writing, or may be any other form of computer bus architecture add-on card known in the industry, such as PCI Local Bus, VL-BUS, ISA, AGP (Accelerated Graphics Port) or the like. Such add-on cards electrically and physically interface with a motherboard (or mainboard) of a computer and abut one of the portals 115. In this manner, when in use, an add-on card generates heat which dissipates via convection current out of the top of the computer case 115, largely sparing other components of the computer, such as a CPU (central processing unit), RAM (random access memory) interfaced into the motherboard, and so forth from the heat generated by the add-on cards.

One add-on card, for example, in an embodiment of the disclosed technology is a video card. The video card, such as a PCI or AGP video card, interfaces with, and sits in, a slot soldered into the motherboard of the computer. One end of the video card, on a side adjacent to the side interfacing with the motherboard, comprises a port for interfacing with a video cable. This port extends through the planar surface of the rectangular portals 115, and the video card is secured in place with a fastening device, such as a screw, clamp, or the like. In this manner, the video card is mounted and secured with the port facing upwards (or towards the top side 110 of the case) and heat generated by the add-on card, which generally rises by way of convection current and exits through the top of the case.

Still referring to FIG. 2, portals 112 are used in embodiments of the disclosed technology to pass wires through and/or secure further items to the case, such as a fan in the round portal 112 and/or USB (universal serial bus) ports or flash card reader connector cables through the T-shaped portal 112.

Above the top side 110 of the case, in embodiments of the disclosed technology, a top panel is placed thereon. This top panel (not shown) fits onto, or attaches to, the computer case, such as to the sides 150 and/or the top side 110. The top panel is situated above the top side 110 and may be part of a cover for the computer case/housing, shown in the figure. As such, between the top panel and top side 110, an air channel is formed. While the top panel makes the computer more esthetically pleasing, the air channel allows for hot air, which rises from the computer case, to exit into the channel and flow out of the case, either because the channel has an opening to the outside which is angled upwards and/or because a fan pushes the air through the channel and out to an opening. Such a fan, as described above, may be placed in a portal 112 and may be parallel to the top of the case or offset at an angle to push the air horizontally across the channel and out of the case.

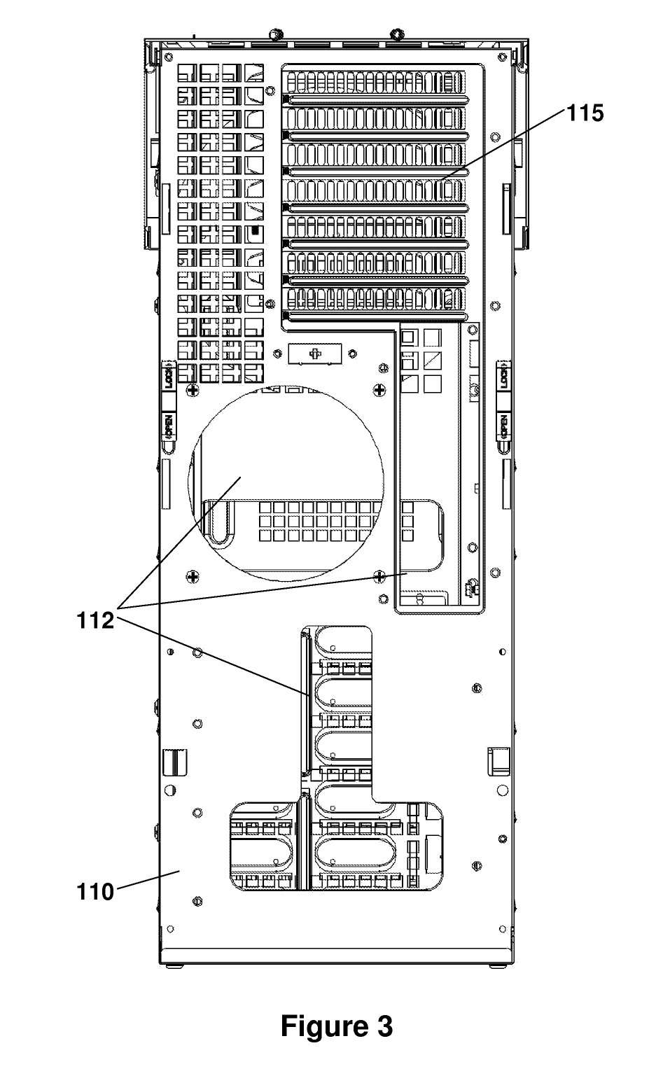

FIG. 3 shows a top view of a case of an embodiment of the disclosed technology. Note the add-on portals 115 (seven shown in the figure), and portals 112 for peripherals. A top cover/panel is situated above this top side 110 of the case, above the top side 110, so as to form a (top) air channel between the case itself and the panel. Thus, hot air rising from the case 115 enters the channel where it may be evacuated from the case. In this regard, a fan, defined as an air moving device, removes heat from the air channel to keep the cables and hardware in the channel from overheating or melting. This design keeps such heat away from the processor and internal components of the computer, allowing them to run at greater speeds and generate more heat, since the heat of the add-on cards is largely evacuated from the case and/or does not enter the case. Similarly, a fan placed in a portal 112 may evacuate heat upwards from the interior of the case, thus using natural convection currents to aid in the expunging of the heat from the central cavity of the computer. In this manner, the air flow within the computer is in its natural direction of flow.

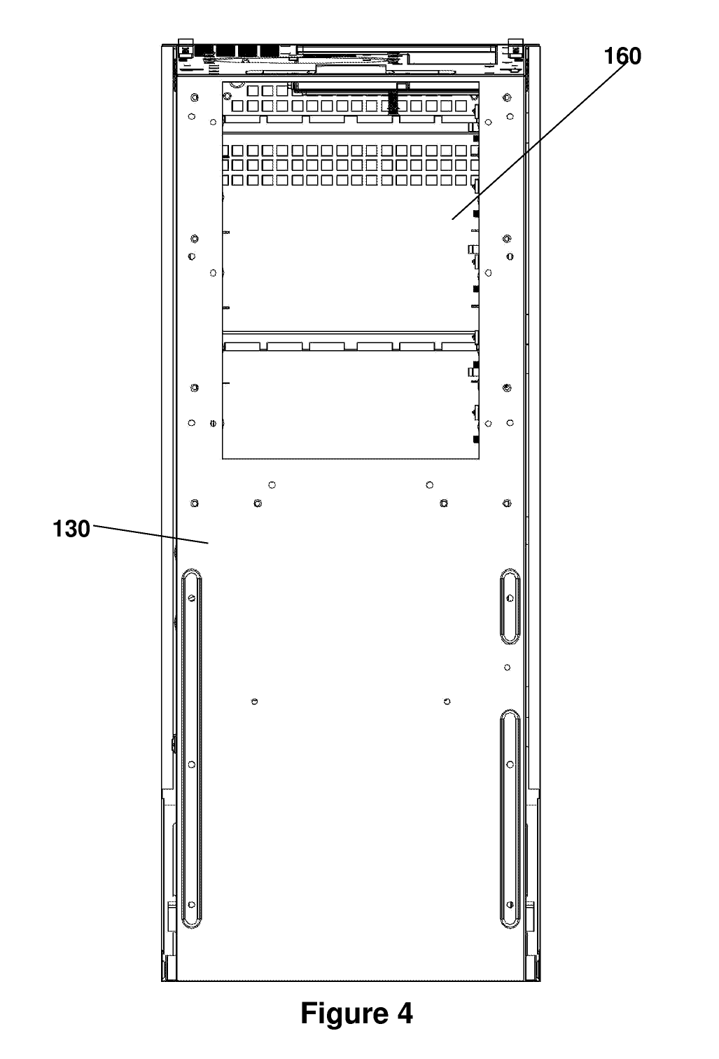

FIG. 4 shows a front side elevation view in an embodiment of the disclosed technology. Note the drive bays 160. From the perspective of this figure, air flow within the cavity of the case is largely in an upward direction. Convection currents push generated heat upwards, as to the fans, where the heat exits through a top portal and channel, as shown in FIG. 3.

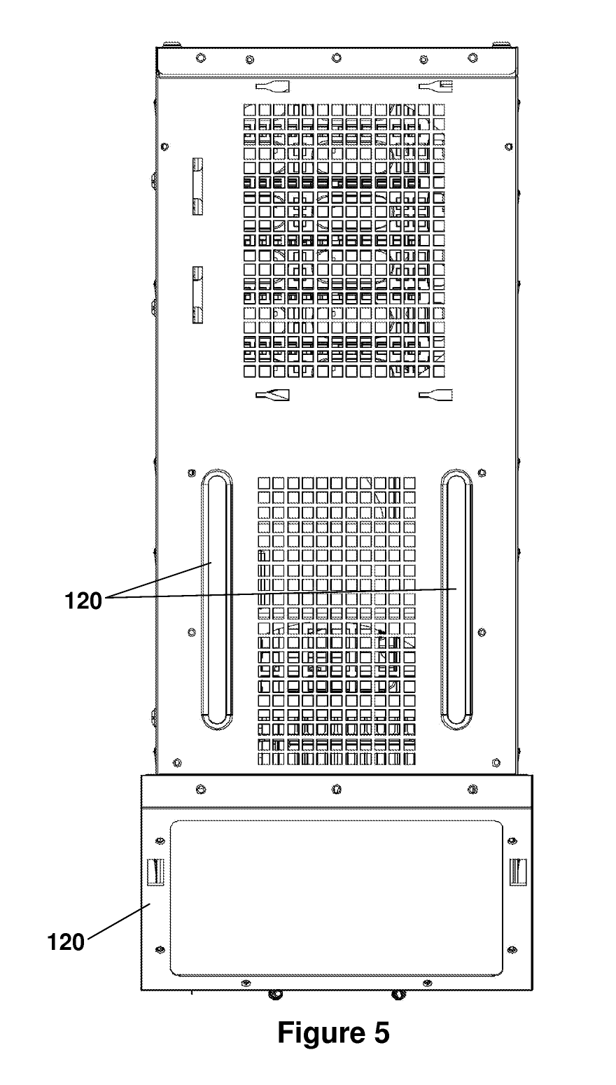

FIG. 5 shows a bottom plan view of a case of an embodiment of the disclosed technology. Feet 120 help prevent slippage or movement of the case when it is placed on a surface. In embodiments of the disclosed technology, the bottom of the case 120 rests on a flat surface and is generally parallel to the top of the case 110. (A top cover may further be generally parallel to the top of the case 110 and bottom of the case 120, or may be angled up and away from the case at a back or front side for the purpose of aiding in heat dissipation.) “Generally,” as used in this disclosure is defined as what one having ordinary skill in the art would consider it to be, or within a 3 degree tolerance level. That is, “generally flat” is defined as what one would consider to be flat or within 3 degrees of being flat from end to end, and so forth. “Generally parallel” is defined likewise.

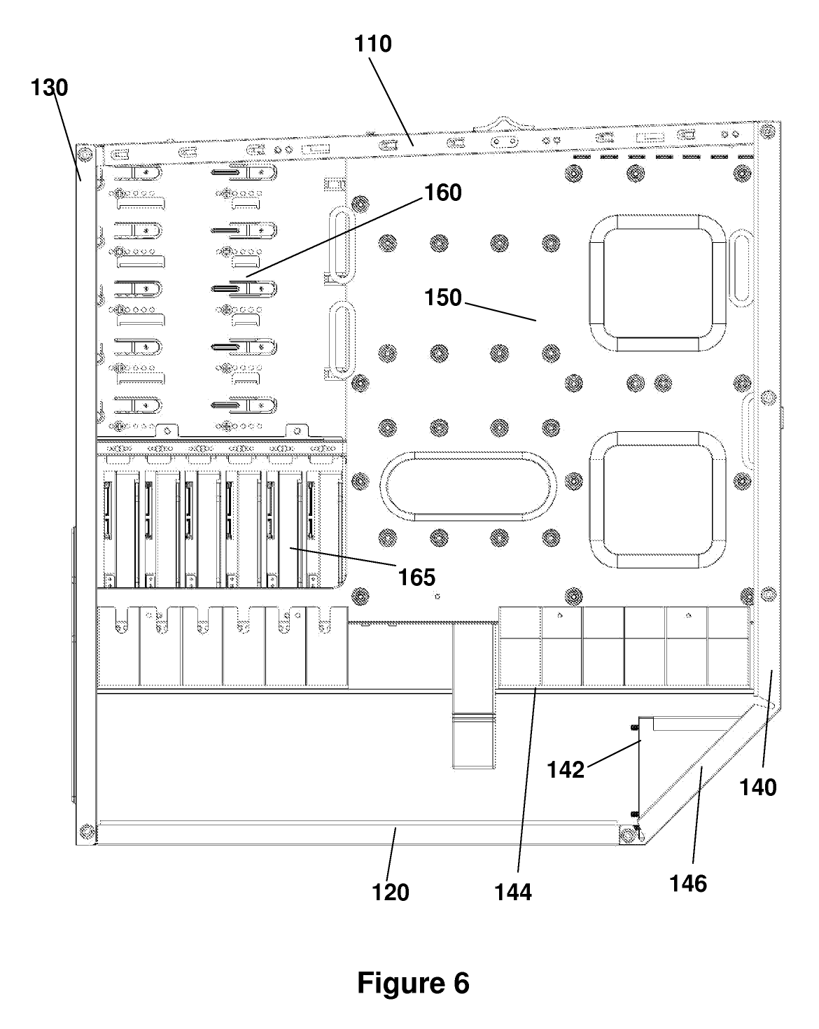

FIG. 6 shows a second side elevation view of another case of an embodiment of the disclosed technology. This figure shows the opposite side of the case compared to that shown in FIG. 1. Here, swappable drive bays 165 are shown for inserting and removing disk drives.

Still referring to FIG. 6, as well as to FIG. 1, in embodiments of the disclosed technology, the back side of the bottom of the case comprises a bracket 145 at a 45 degree angle (or generally at a 45 degree angle), in addition to a right angle connection at the corner of the bottom 120 and back 140 sides. This bracket adds structural support. A further bracket 144, in embodiments of the disclosed technology, extends from side to side and front to back of the case, though with portals therein for passage of cables. In embodiments, a power supply is placed in the lower portion of the case formed between the bracket 144 and lower end of the case 120. This aids in cable management, shielding of radiation (from the power supply to other components of the computer), and air flow, as the power supply heat is kept largely separate from the rest of the computer components.

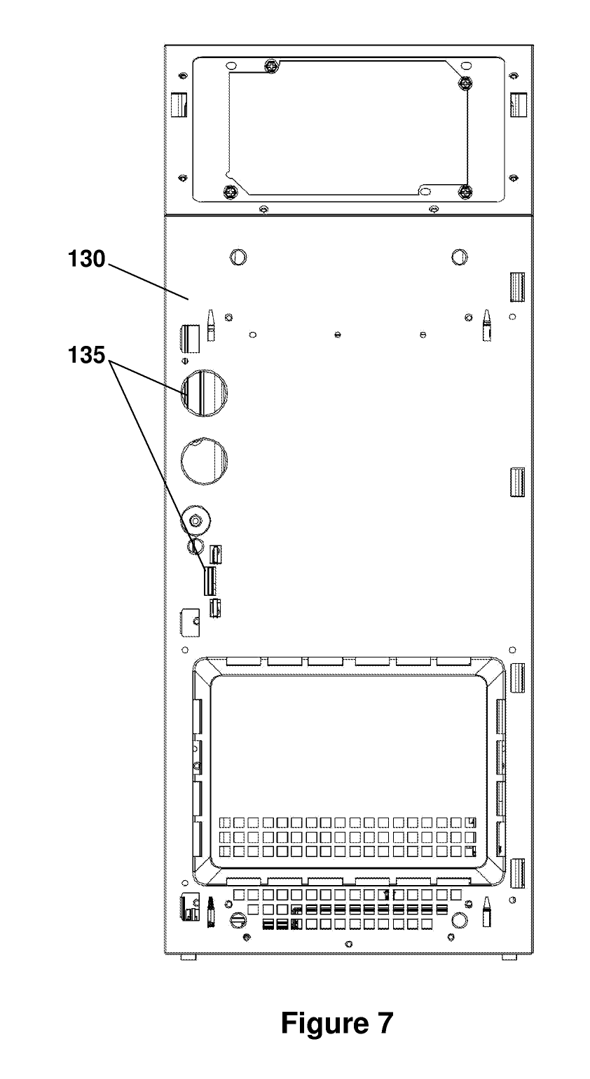

FIG. 7 shows a back side elevation view of a case of an embodiment of the disclosed technology. Further ports 135 may be placed on the back side.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

I claim:

1. A computer case comprising top, bottom, left, right, front, and rear sides formed around an internal cavity;
said bottom side being generally elongated and flat and comprising at least one foot extending outward from said generally elongated and flat side and adapted for stable placement on a surface;
said top side being generally parallel to said elongated and flat bottom side and comprising a top air channel formed between said top side and a top side cover; and
said top side further comprising a series of rectangular portals between said internal cavity and said air channel, each said rectangular portal adapted for fixed abutment to an add-on card.

2. The computer case of claim 1, wherein said front side further comprises at least one switch operable to affect a function of a computer.

3. The computer case of claim 1, wherein said top panel further comprises an electrical port, said electrical port being electrically connected to a motherboard housed within said case.

4. The computer case of claim 1, wherein said case further comprises means for mounting said motherboard to said case, whereby add-on slots of said motherboard are mounted such that an exterior side of a said add-on card seating in said slot abuts a said rectangular portal.

5. The computer case of claim 4, wherein a bottom air channel is formed between said bottom side and a bottom divider.

6. The computer case of claim 5, wherein said bottom air channel comprises a power supply.

7. The computer case of claim 6, further comprising a fan directing air from said internal cavity into said top air channel and to an exterior of said case.

8. The computer case of claim 7, wherein a said add-on card is a video card and is abutting a said rectangular slot, said video card comprising a video port situated in said top air channel.

9. The computer case of claim 8, wherein a joint at ninety degree angle connects said back and said bottom sides, and a plate at a forty-five degree angle further connects said back and said bottom sides.

10. The computer case of claim 9, wherein said front side comprises drive bays and said rectangular portals are located at a back portion of said top side.

11. A method of orienting devices within a computer case, said computer case comprising top, bottom, left, right, front, and rear sides formed around an internal cavity, said method comprising:
placing said bottom of said computer case on a generally flat surface, by way of feet attached to said bottom of said computer case;
extending an exterior portion of at least one add-on card through an add-on slot, said exterior portion pointed upwards;
placing a top side cover over said top side of said computer case and forming an air channel between said exterior portion of said add-on card and said top panel; and
electrically connecting at least one fan to a motherboard housed within said computer case.

12. The method of claim 11, wherein said front side further comprises at least one switch operable to affect a function of a computer.

13. The method of claim 11, wherein said top panel further comprises an electrical port, said electrical port electrically connected to a motherboard housed within said case.

14. The method of claim 11, wherein said method further comprises a step of mounting said motherboard to said case, wherein said motherboard comprises said add-on slots, and a step of mounting said add-on card to a said add-on slot, whereby said add-on card abuts a rectangular portal of said top side.

15. The method of claim 11, wherein a bottom air channel is formed between said bottom side and a bottom divider.

16. The method of claim 15, wherein said bottom air channel comprises a power supply.

17. The method of claim 16, wherein said fan directs air from said internal cavity into said top air channel and to an exterior of said case.

18. The method of claim 17, wherein a said add-on card is a video card and abuts a rectangular slot, said video card comprising a video port situated in said top air channel.

19. The method of claim 18, wherein a joint at a ninety degree angle connects said back and said bottom sides, and a plate at a forty-five degree angle further connects said back and said bottom sides.

20. The method of claim 19, wherein said front side comprises drive bays and said rectangular portals are located at a back portion of said top side.
